(19) United States
(12) Patent Application Publication
(10) Pub. No.: US 2007/0174664 A1
(43) Pub. Date: Jul. 26, 2007

(54) Data recovery application

(75) Inventors: Benjamin A. Carmitchel, Highland, IL (US); Nathan W. Wright, Alton, IL (US)

Correspondence Address: POLSTER, LIEDER, WOODRUFF & LUCCHESI, 12412 POWERSCOURT DRIVE SUITE 200, ST. LOUIS, MO, 63131-3615, US

(73) Assignee: ESS Data Recovery, Inc.

(21) Appl. No.: 11/325,098

(22) Filed: Jan. 4, 2006

(51) Int. Cl. G06F 11/00

(52) U.S. Cl. 714/5

(57) ABSTRACT

A system for the recovery of data from a failing or failed hard drive including a computer, computer software and a chamber. The computer has a first hard drive and a second hard drive attached thereto. The first hard is the failed or failing hard drive, and the second hard drive is a hard drive to which data may be copied from the first hard drive. The computer software is executed by the computer for copying data contained on the first hard drive to the second hard drive. The chamber encloses at least the first hard drive. The chamber is in communication with the computer and is capable of altering at least one property of environment within the chamber programmatically at direction of the computer software in order to recover data from the first hard drive that was not readable by the computer before the property of environment was altered. An example of the properties are pressure, temperature, spindle motor current and vibration.

### FIELD OF THE INVENTION

The invention relates to computer software and hardware. More specifically, the invention relates to software for recovery of data from a failing hard drive.

### BACKGROUND OF THE INVENTION

While computer hard drives have continued to improve in capacity, performance and reliability, computer hard drives continue to be one of the most unreliable components of a personal computer. A hard drive is the primary medium for storing information on computers, because it combines high capacity, relatively fast access and low price. A hard disk drive is made up of four basic components: a motor, a spinning platter, a pivoting arm with a read/write head on its end and electronics to tie everything together and connect it to a processor.

Because computer hard drives normally represent the primary static storage medium for a personal computer, computer users rely heavily upon computer hard drives for the safekeeping of their data. For mission critical data, daily backups are normally made onto another static media such as tape backups, removable media drives, such as CD and DVD media and decreasingly floppy drives, and increasingly solid state devices, such as USB flash drives. Most users realize the need to back up computer hard drives on a regular basis. However, while some users still do not understand the importance, others simply do not backup their computer hard drives do to the time involved or lack of understanding or desire to complete the necessary steps. Even with diligent computer hard drive backup procedures, it is possible that important data will be list on a failing hard drive because it was created between computer backups.

Previously, software programs for recovery data from failing hard drives existed. However, these programs are designed to address logical problems, not physically damaged medium. There are various problems that can occur with a computer hard drive and no software provides automatic operation to locate the source of the hardware problem, correct the problem as best can be corrected and recover as much data from the computer hard drive as possible. Therefore, in the past there has been no computer software available to recover data from a failing hard drive.

### SUMMARY OF THE INVENTION

The present invention provides a system for the recovery of data from a failing or failed hard drive comprising a computer, computer software and a chamber. The computer comprises a first hard drive and a second hard drive attached thereto. The first hard is the failed or failing hard drive, and the second hard drive is a hard drive to which data may be copied from the first hard drive. The computer software is executed by the computer for copying data contained on the first hard drive to the second hard drive. The chamber encloses the first hard (failed) drive. The chamber is in communication with the computer and is capable of altering at least one property of the physical environment within the chamber programmatically at direction of the computer software in order to recover data from the first hard drive that was not readable by the computer before the property of environment was altered.

### BRIEF DESCRIPTION OF THE DRAWINGS

FIG. 1 is a diagram according to an embodiment of the present invention;

FIG. 2 is a flow chart of the main flow of the software according to an embodiment of the present invention;

FIG. 3 is a diagram of an introductory interface according to an embodiment of the present invention;

FIG. 4 is a diagram of a main interface according to an embodiment of the present invention;

FIG. 5 is diagram of a read drive interface according to an embodiment of the present invention

FIG. 6 is a diagram of an error interface according to an embodiment of the present invention;

FIG. 7 is diagram of a write drive interface according to an embodiment of the present invention;

FIG. 8 is a diagram of a confirmation interface according to an embodiment of the present invention;

FIG. 9 is a diagram of a image file name interface according to an embodiment of the present invention;

FIG. 10 is a diagram of a select file type interface according to an embodiment of the present invention;

FIG. 11 is a clone drive forwards flow chart according to an embodiment of the present invention;

FIG. 12 is a clone drive backward flow chart according to an embodiment of the present invention;

FIG. 13 is a save as *.img flow chart according to an embodiment of the present invention;

FIG. 14 is a clone MFT then hard drive forward flow chart according to an embodiment of the present invention;

FIG. 15 is a skip bad sectors flow chart according to an embodiment of the present invention;

FIG. 16 is a data verification flow chart according to an embodiment of the present invention;

FIG. 17 is an erase or replace G-list flow chart according to an embodiment of the present invention;

FIG. 18 is a hard drive power on/power off flow chart according to an embodiment of the present invention;

FIG. 19 is a hard drive temperature flow chart according to an embodiment of the present invention;

FIG. 20 is a hard drive vibration flow chart according to an embodiment of the present invention; and

FIG. 21 is a hard drive pressure flow chart according to an embodiment of the present invention.

### DESCRIPTION OF THE PREFERRED EMBODIMENT

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The preferred embodiment of the present invention comprises a software application for execution on a computer, preferably a personal computer or laptop computer, to provide a mirroring or cloning solution for creating a backup copy of a failed or failing hard disk drive. The present invention accomplishes this by using a proprietary hardware/software combination.

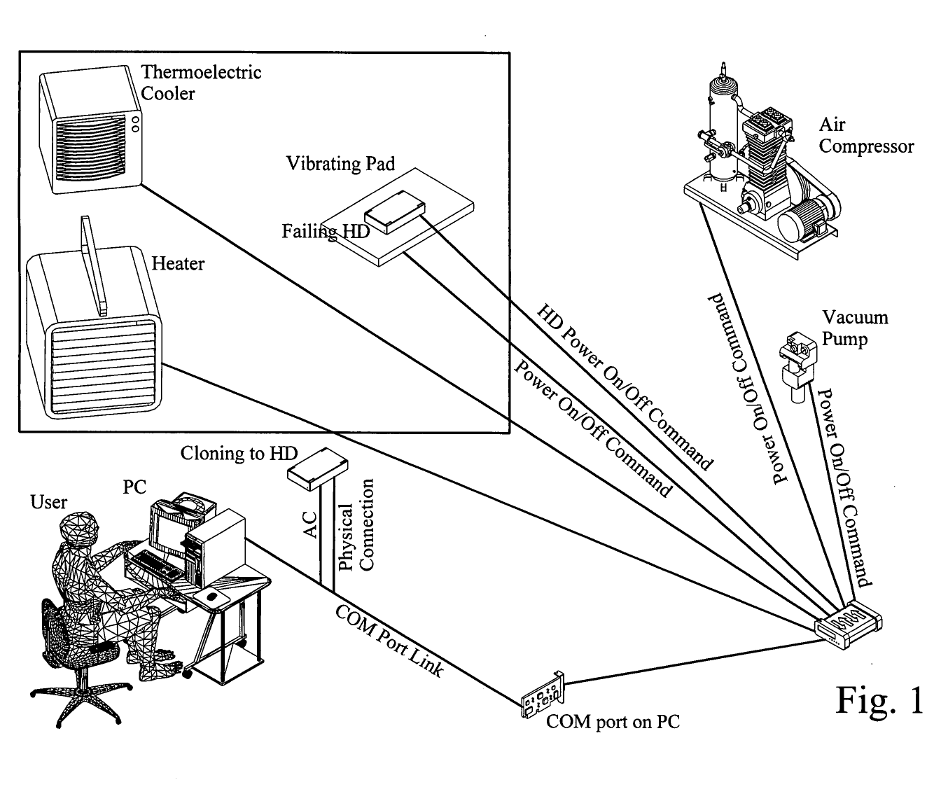

In this regard and referring to FIG. 1, a computer designated as reference numeral 100 is attached to a hard drive 102. The hard drive 102 is a “target” drive and holds information to be retrieved from a failed or failing hard drive 104. The failed or failing hard drive 104 is located within a chamber 106 that is sealed such that it can be pressurized, vibrated, heated and cooled and turned off and on in a controlled environment and is attached to the computer. The hard drives may be directly attached to the computer or attached through a computer network. The chamber 106 communicates with a communications port 108 on the computer 100, such as a serial port, parallel port, USB port, firewire port, Ethernet port, wireless communication interface or other communication interface of the computer 100. The chamber 106 has a relay 110 which receives commands from the computer 100 through the port. The relay 110 controls power to an air compressor 112, a vacuum pump 114, a heater 116, an air conditioner 118, a vibrating pad 120 and the failed or failing hard drive 104 itself. The air compressor 122 increases the air pressure within the chamber 106 to pressures above ambient pressure. The vacuum pump 122, alternatively, decreases the air pressure within the chamber 106 to pressures below ambient pressure. The air conditioner 118 and heater 116 work to decrease or increase the temperature within the chamber 106. The vibrating pad 120 provides varying levels of vibration to the hard drive 104 within the chamber 106. By altering temperature, pressure and vibration, the failed or failing hard drive 104 may be made to operate where it would not previous operate in ambient pressure and room temperature and without vibration. In this manner, the hard drive 104 may be made to operate long enough to recover its data. These variables make data cloning possible by causing slight changes to hard drive head read height, metallic expansion/contraction of the hard drive platter media, corrupted hard drive microcode correction, amplifying current and signal frequency to the spindle motor, by introducing magnetic noise in order to electronically filter harmful noise, or by avoiding bad sectors on the medium.

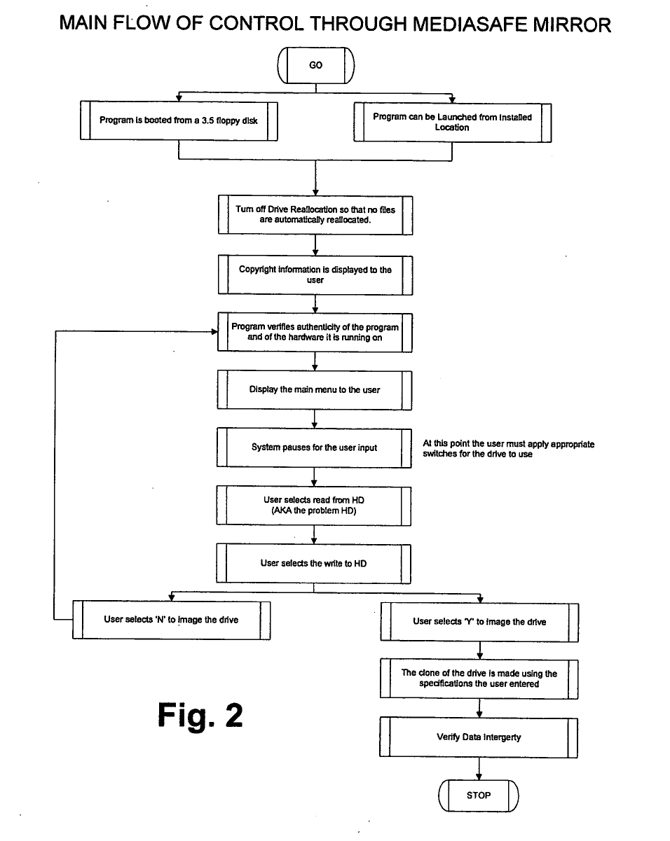

The software causes the computer to act to control the air compressor 112, vacuum pump 114, heater 116, air conditioner 118, vibrating pad 120 and the power to the failed or failing hard drive 104. The interface of FIG. 2 allows the user to determine which factors of environment will be manipulated as well as options and strategies for recovering all of the data, or as much data as possible.

Referring to the flow chart of FIG. 2, the main flow of steps undertaken by the software is provided. Initially, software may be stored on and started from a removable media, such as a floppy disk, CD-ROM, DVD-ROM or other removable storage media, or it may be stored on and started from an installed location of a computer hard drive attached to the computer 100.

When the removable media option is used, not all of the features of the present invention may be provided, but essentially the same cloning methods are performed and the same options are available with minor variations. Another manner in which the present invention can be executed through a second start action by operating the program after it has been installed onto the user's personal computer just as any other type of software would be installed. The invention will provide an installation shield to help the end user properly install the program on to the user's computer, as is known in the art.

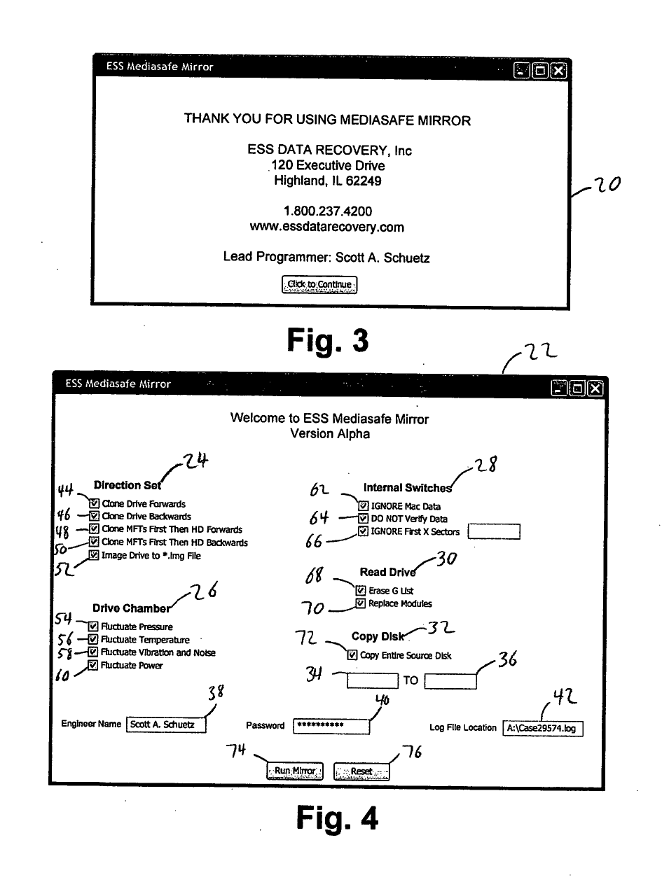

Next, the software turns off drive reallocation so that no sectors are automatically reallocated. This procedure prevents the hard drive's microcode from unnecessarily attempting to repair bad sectors on a failing hard drive. This increases speed and success of the clone. Next, upon executing the software, the user is shown an introductory interface 20 that provides information about the software, as shown in FIG. 3. After the user progresses past the introductory interface 20, the software determines the authenticity of its installation. This is done to prevent end users of the software of the present invention from distributing illegal copies of the program. Several key components are verified by the program to ensure integrity of the computer it is installed on. Key components that are verified are CPU number, motherboard make and model number, and if booting with a floppy disk the serial number of the floppy drive. All verification methods are conducted using standard processes.

The user is next provided with the main interface 22 of FIG. 4. In this interface, various methods for attempting to recover data from the failed or failing hard drive 104 are presented. Specifically, the user can select which methods he does or does not wish to attempt in order to recover the data. The methods are subdivided into groups which control the direction in which the hard drive surface is scanned in order to recover data (direction set 24), the features of a hard drive chamber 106 that can be manipulated in order to affect data recovery (drive chamber 26), internal features of the software itself that may be manipulated in order to affect data recovery (internal switches 28), features of the hard drive 104 that may be changed in order to affect data recovery (read drive 30), and features of the hard drive 102 that may be affected by software (copy disk 32).

Additionally, the interface of FIG. 4 receives a login name 38, password 40 and displays the location of a log file 42 that logs actions taken and errors determined by the software and results of those actions for later review.

Grouped under direction set 24, one and only one direction set option 44-52 can be chosen simultaneously. Other options 54-72 grouped under different option sets 26-32 may be chosen in any combination. The options 44-72 will be explained in greater detail below.

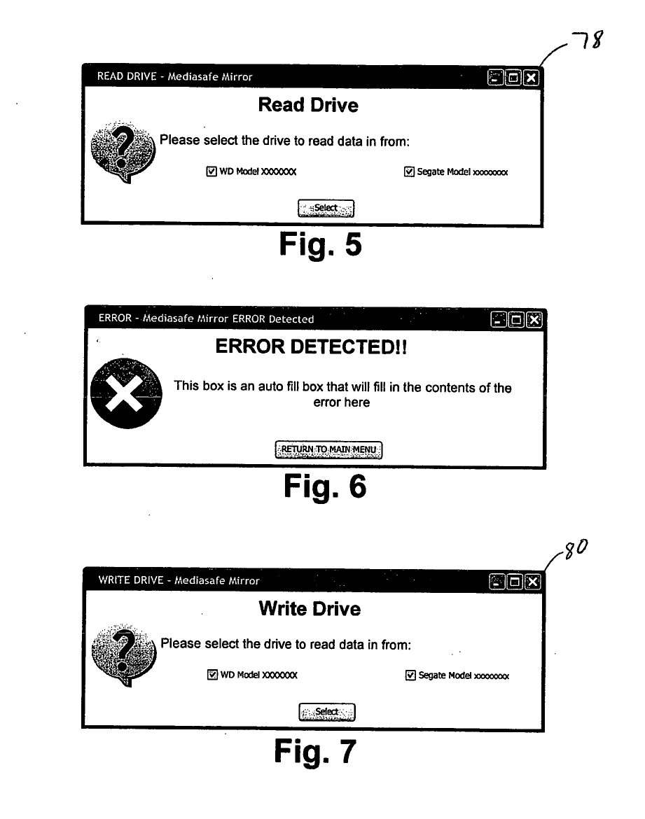

After a RUN MIRROR command button 74 is depressed, a smaller interface 78, shown in FIG. 5, will be displayed to the user unless there is an error, in which case an error display, as shown in FIG. 6, will be displayed to the user identifying the error. The interface 78 asks the user to select from among the hard drives 102 and 104 attached to the computer the hard drive that is the failed or failing hard drive or “the read drive”.

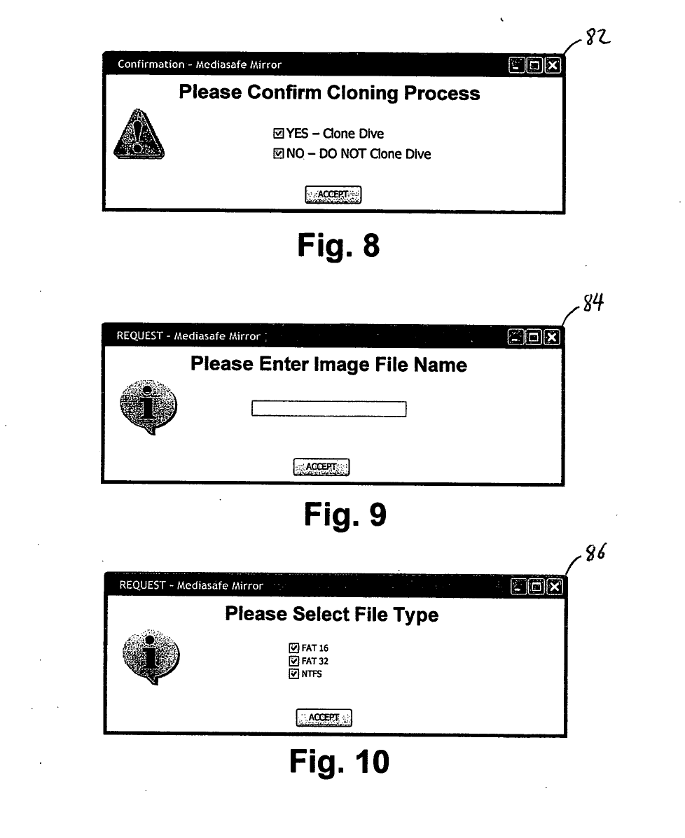

After the user has selected the identity of the failed or failing hard drive 104 in FIG. 5, the interface 80 asks the user to identify which hard drive 102 or 104 should be used for writing the recovered data, in FIG. 7. After the user has identified which hard drive 102 or 104 should be used for writing the recovered data (“the target drive”), the interface 82 of FIG. 8 requests the user to confirm whether to clone the failing hard drive, and then, in the interface 84 of FIG. 9, requests the user to enter a hard drive image filename in a text box 86, if an image drive to *.img option 52 is selected (described below). In the interface 88 of FIG. 10, if the software cannot determine the hard drive format and the user selected the options 48 or 50, the software will request the user to identify which hard drive format the failed or failing hard drive has.

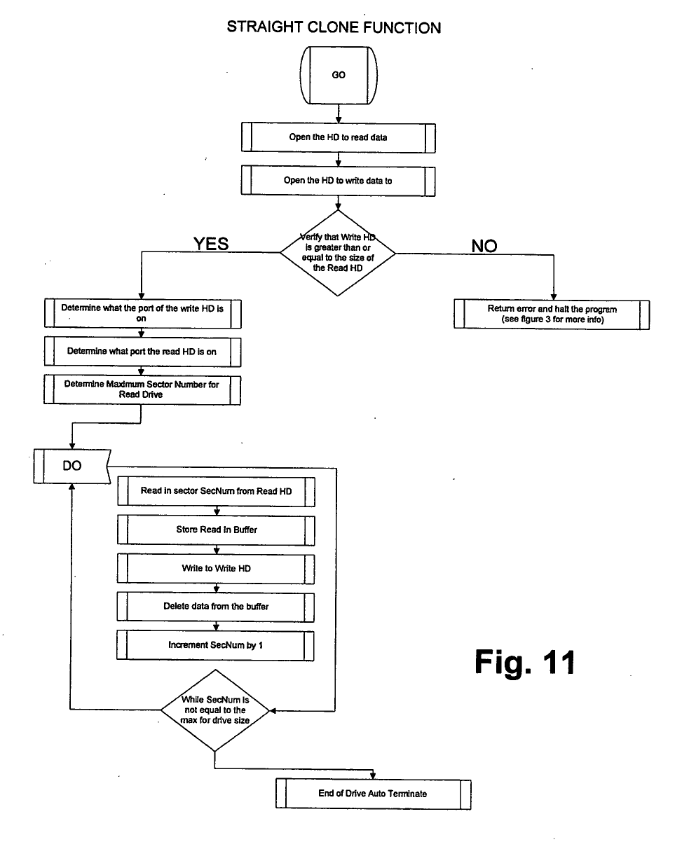

Now the options 44-52 are explained in greater detail. If under the direction set 24 (FIG. 2) the clone drive forward option 44 has been selected, the steps of FIG. 11 are performed.

Next, the software verifies that the hard drive 102 is equal to or larger than the hard drive 104 in capacity. If it is not, an error is displayed with the interface of FIG. 6 displaying the nature of the error. If it the hard drive 102 is larger, the software continues to the next step by determining on what IDE port the hard drive 102 is located, on what IDE port the hard drive 104 is located and the maximum sector number for the hard drive 104. Data will be written to the drives 102 and 104 faster using direct referencing of the port number rather than relative addressing. If the software cannot obtain the physical port address it will continue at a slower PIO mode. Additionally, if the hard drive 102 is encountering many read errors the drive will automatically drop down to a lower PIO mode automatically. While IDE ports are described, one of ordinary skill in the art would recognize that other hard drive interface technologies can be used, for example, SCSI hard drive interfaces or other known hard drive interfaces.

The software then loops through a cycle of reading in a sector number stored in a SecNum variable of the hard drive 104, starting with sector 0, storing the data from the sector in a read buffer, writing the data to the hard drive 102, deleting the data from the buffer, incrementing the SecNum variable by 1 and continuing the loop again. The cycle repeats until all sectors of the hard drive 104 have been read. When the loop is completed successfully, the data from the hard drive 104 will be copied to the hard drive 102.

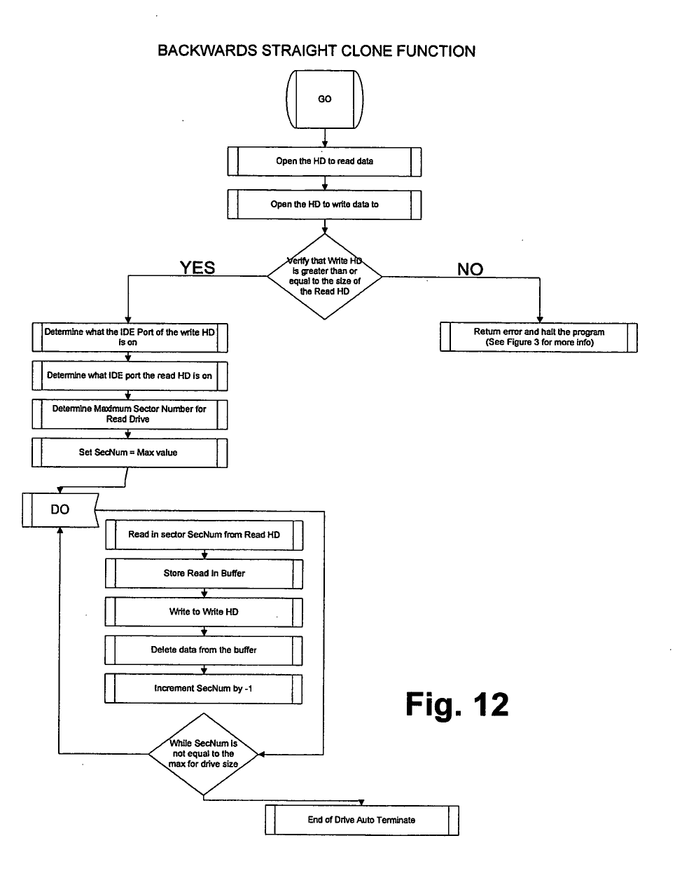

If under the direction set 24, the clone drive backward option 46 has been selected, the steps of FIG. 12 are performed in a similar manner as with the clone drive forwards option 44, but the sectors are read in reverse order. Specifically, as with the clone drive forward option 44, in a first step, the software opens the failed or failing hard drive 104 from which it will read data. Subsequently, the software opens the hard drive 102 to which it will write recovered data. Next, the software verifies that the hard drive 102 is equal to or larger than the hard drive 104 in capacity. If it is not, the software displays an error, as above. If it the hard drive 102 is larger, the software continues by determining on what IDE port the hard drive 102 is located, on what IDE port the hard drive 104 is located and the maximum sector number for the hard drive 104. A SecNum variable is set to the value of the maximum sector number. Then, as above, the software loops through a cycle of reading in a sector number of the hard drive 104 stored in a SecNum variable, storing the data in a read buffer, writing the data to the hard drive 102, deleting the data from the buffer, decrementing the SecNum variable by 1 and continuing the loop again. The cycle repeats until all sectors of the hard drive 104 have been read. As before, when the loop is completed successfully, the data from the hard drive 104 will be copied to the hard drive 102.

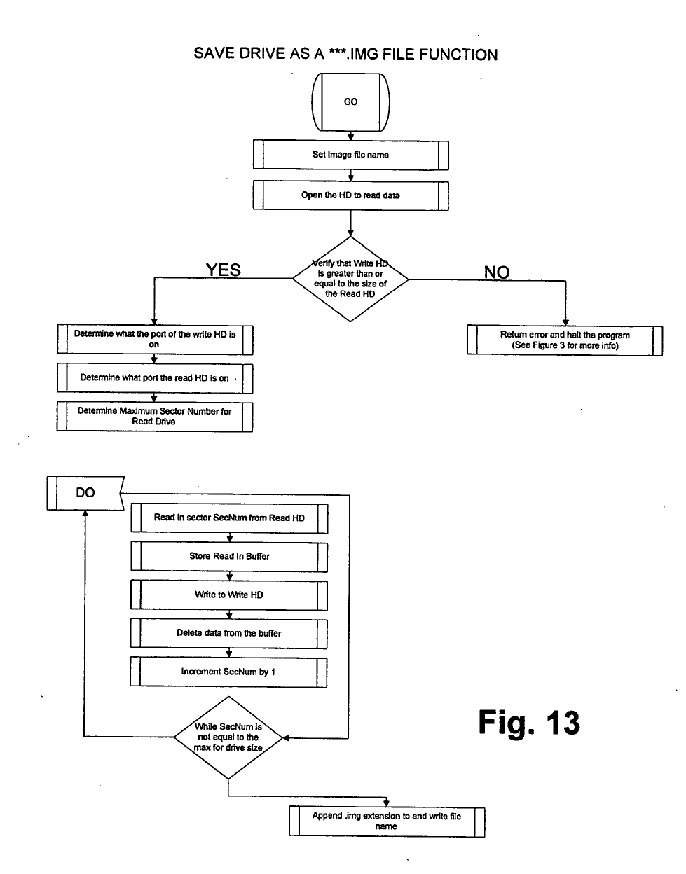

If under the direction set 24, the image drive to *.img file option 52 has been selected, the steps of FIG. 13 are performed in similar manner as with the clone drive forwards option 44, but an *.img extension is added to the written data and the data appears as a single file on the hard drive 102. In a first step, the process prompts the user to enter a name for the image file that is going to be created by the program, by using the interface of FIG. 9. The program will not continue until the image name is entered. The remaining steps of the process are the same as the clone drive forwards option 44 except that data is written out to a standard image file format and in the final step a “.img” extension is written to the file.

When a clone MFTs first then hard drive forwards option 48 is selected under the direction set 24, the software first acts to copy the sectors of the hard drive 104 that contain the master file table (“MFT”) of the hard drive 104 and then copy all of the sectors of the hard drive 104. This function simply goes into the hard drive 104 and copies out the MFT first, if it exists at all. If the hard drive does not contain an NTFS volume, then the software will automatically copy data forward or backward as described. This allows the end user to do partial recoveries on the failed hard drive because all of the information to identify the files has been recovered.

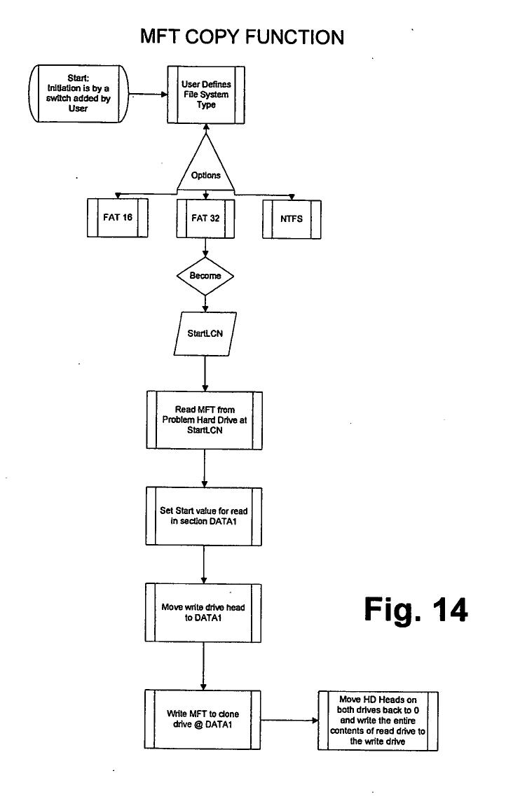

Referring to FIG. 14, this process is started by the user indicating through the interface of FIG. 10 which format the hard drive 104 uses if it cannot be automatically determined. Presently popular hard drive formats are FAT, FAT32 and NTFS. Other formats may be implemented, as one of ordinary skill in the art would readily recognize. Based on the user's response, and information read from the partition table and NTFS boot sector, the software will understand where to begin copying the MFT. The software then reads in the MFT based on the predefined start location for a particular hard drive format.

In the next step, the write head on the hard drive 102 is moved to the location stored in DATA1 and is followed by a step where the data is written at the location of DATA1. Finally, the hard drive heads on both hard drive 102 and hard drive 104 are moved back to zero and the entire contents of the drive 104 are copied to the drive 102 using the steps described in FIG. 11.

When the clone MFTs first then hard drive backwards option 50 is selected under the direction set 24, the same steps of FIG. 14 are performed except the hard drive 104 is copied using the steps of FIG. 12 rather than FIG. 11 at the after the last step of FIG. 14.

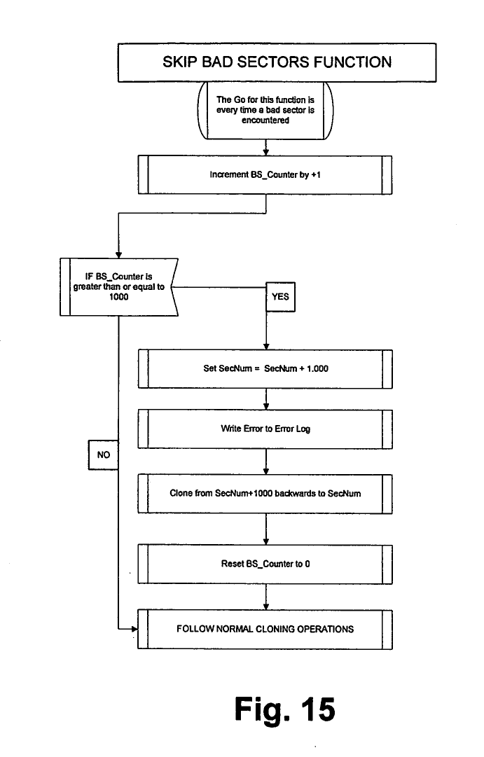

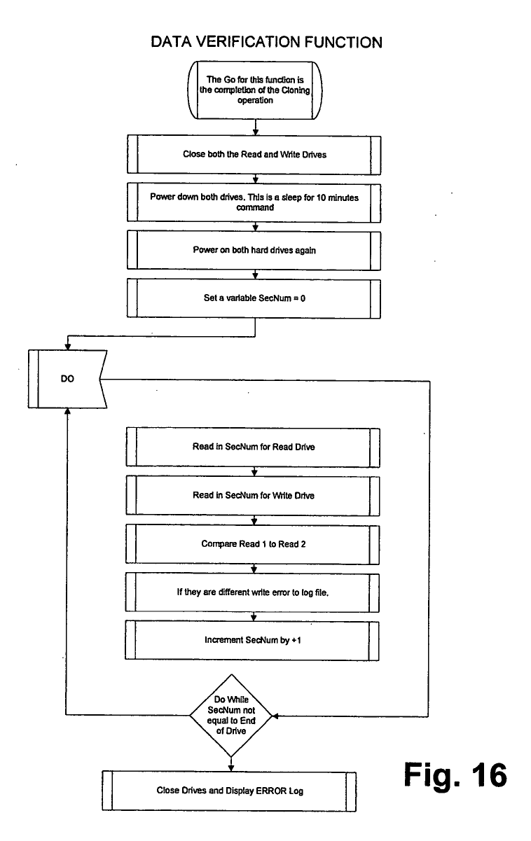

As described, the direction set 24 options are implemented exclusively of each other and dictate the overall strategy for retrieving the data from a failed or failing hard drive. The remaining option sets 26-32 provide features which can be implemented when retrieving data with a particular direction set 24. When retrieving data from the hard drive 104 while using one of the direction sets 24, certain events or “go functions” trigger other operations to temporarily interrupt the data retrieval. One example is a bad sector skipping routine. At certain times bad sectors appear in contiguous groups. Reasons for this include material defects in the hard drive disk or the hard drive heads having physically struck the disk causing surface defects of the disk at an isolated location. In such situations when a large number of bad sectors are found, skipping a large number of sectors and reading backwards until the defective area is once again reached is more effective at recovering the data. Referring to FIG. 15, a bad sector skipping routine is triggered by the go function of the occurrence of a bad sector from which data is not easily or immediately read. When a bad sector is found, a BS_Counter variable, which initially begins at zero, is incremented by one. In a next step, if the value of the BS_Counter variable is less than 1000, normal cloning operations are resumed. If the value of the BS_Counter variable is 1000 or more, the SecNum variable is incremented by 1000 and an error is written to the error log indicating that 1000 sectors were skipped. In a next step, the software begins attempting to read data from the newly incremented SecNum sector value backward sector-by-sector to the new value of SecNum minus 1000. When all sectors have been attempted to be read back to the original value of SecNum, the value of the BS_Counter variable is set to zero and normal operations are resumed by cloning from the newly incremented value of SecNum forward. If cloning is backwards, SecNum decreased by 1000 and then read forward back to the bad area.

As a default, after data has been retrieved using a particular direction set 24, the data is verified unless a DO NOT verify data option 64 has been selected. During data verification, the steps of FIG. 16 are performed. The go function for the data verification steps is the completion of cloning using one of the direction sets 24. When this go function is triggered, the software closes both the hard drive 104 and the hard drive 102. Next, the software causes the computer 100 to communicate to the relay 110 to power down both hard drives 102 and 104 in order to verify the integrity of the hard drive 104 and to make sure that all write and execute statements have stopped.

Other operations that can be implemented are the erase G list option 68 and the replace G list option 70. Hard drives have what is referred to as a P-list and a G-list. The P-list is a primary defect list. The primary defect list is a list of defective sectors in a hard drive as it originates from the factory. The defective sectors may not be used for storing data. The P-List is generated as part of the manufacture of the hard drive, and the disk itself stores the list internally. Therefore, as a result of being listed on the P-List, the sectors should never have been used for storing data. On the other hand, the G-List (short for “Growing Defect List”) is a list stored on a hard drive containing hard drive sectors that originally were capable of storing data upon construction of the hard drive, but can no longer function to reliably store data. The list is updated by the drive itself and stored internally on the drive. The information in this list may help indicate the current state of the drive. A large number of entries in the G-List may indicate an early start of a defective hard drive. Due to defective media or heads, often this list is written so many times that it either fills up or becomes corrupted, causing the microcode to halt at disk start-up. By erasing or replacing this G-list, the hard drive is made to again function normally so as to copy its data.

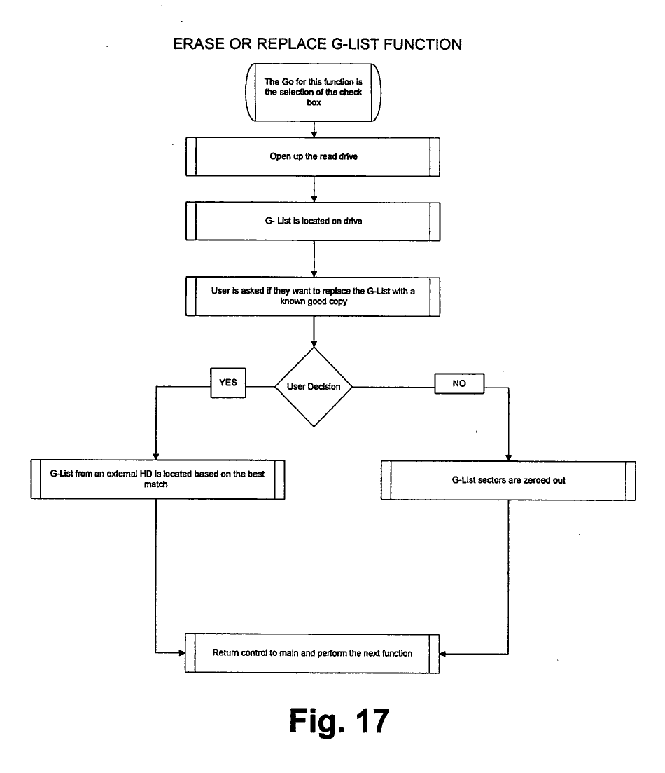

When the erase G list option 68 and the replace G list option 70 are selected, the go function for the steps of FIG. 17 is generated. The first step is to open the hard drive 104 for reading and prepare it to have data read off of the hard drive 104. It also tests the hard drive heads to make sure that they are free and can move from one location to another.

Next, the G-List is located on the hard drive 104. This is done by accessing a database of known G-List locations and comparing the model number of hard drive 104 to this database. The software will continue by asking the user if the user wants to replace the G-list with a known good copy from a database of G-List modules stored within files included with the software.

If the user's decision is NO, the G-List is written over with zeros, and the software exits the steps of FIG. 17 and returns to the direction set 24 function. If the user's decision is yes then the software retrieves copies of known good G-lists and searches for a match and then replaces the G-List on the hard drive 104 with the known good G-List and returns to the direction set 24 function.

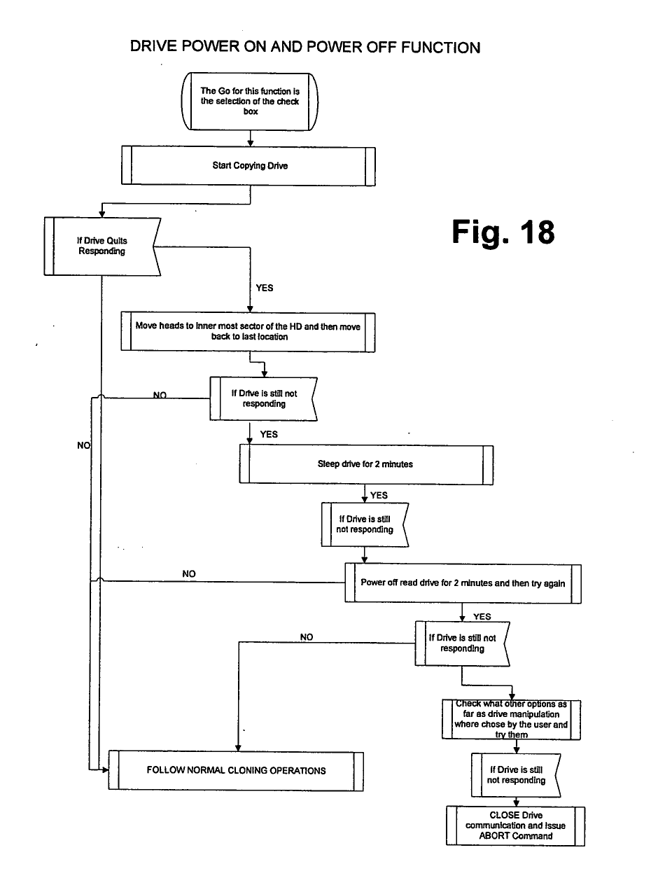

Other operations that can be implemented during the function of the steps of the chosen direction set 24 is the fluctuate power option 60. Referring to FIG. 18, the fluctuate power option 60 is triggered by the go function of the selection of the option 60. If during copying using one of the direction sets 24, the hard drive 104 quits responding, the heads of the hard drive 104 are moved to the inner most sector and then back to the previous location where the drive quit responding. If at this point, the hard drive 104 responds, the steps of FIG. 18 are exited and data retrieval begins again. If the hard drive 104 still will not respond, the hard drive 104 is put in a sleep mode for 2 minutes. If after being in the sleep mode for two minutes, the hard drive 104 responds, the steps of FIG. 18 are exited and data retrieval begins again. If the hard drive 104 still will not respond, the hard drive 104 is powered off for two minutes by the software causing the computer 100 to signal the relay 110 to remove the power to the hard drive 104. If after the expiration of two minutes the hard drive 104 begins responding again when power is restored, the steps of FIG. 18 are exited and data retrieval begins again. If the hard drive 104 still will not respond, the software checks what other options of options 54-58, explained below, are selected and tries those options. If none of those options are selected, data retrieval is discontinued.

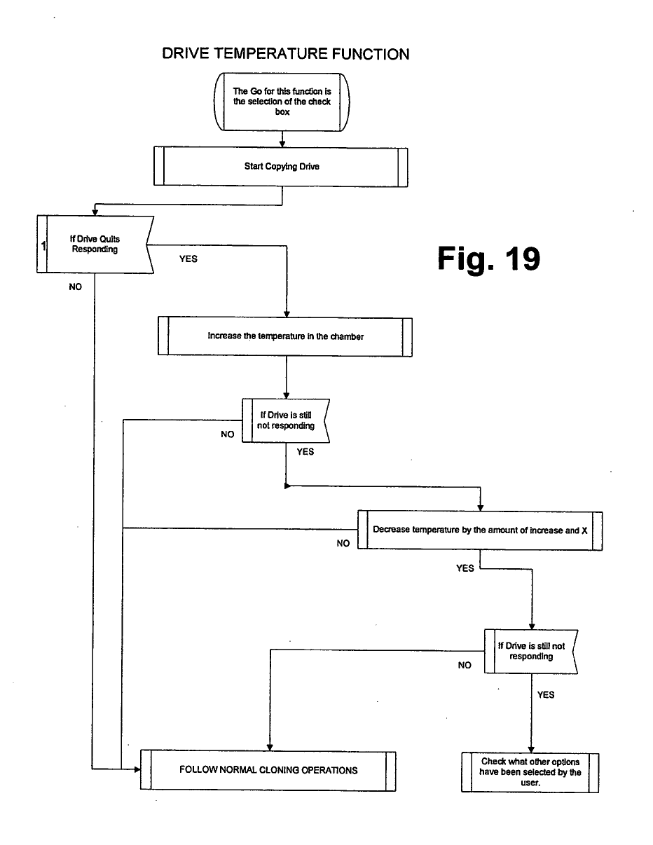

Another operation that can be implemented during the function of the steps of the chosen direction set 24 if the hard drive 104 quits responding is the fluctuate temperature option 56. Referring to FIG. 19, the fluctuate temperature option 56 is triggered by the go function of the selection of the option 56, but is implemented after the fluctuate power option, if it was selected, and only if it was unsuccessful. If during copying using one of the direction sets 24, the hard drive 104 quits responding and the fluctuate power option, if selected, is unsuccessful, the temperature in the chamber 106 is increased by 15 degrees Fahrenheit by the computer 100 signaling the relay 110 which, in turn, controls the heater 116. When ten minutes have expired and the hard drive 104 has not begun to respond, the temperature in the chamber is slowly decreased by 30 degrees Fahrenheit by the software causing the computer 100 to signal the relay 110 which controls the thermoelectric cooler 118. If the hard drive fails to respond after this procedure, data retrieval is discontinued and both drives are powered off. If at any time the hard drive 104 begins to respond with the increase or decrease in temperature or after the sleep modes, the steps of FIG. 19 are exited and data retrieval is continued.

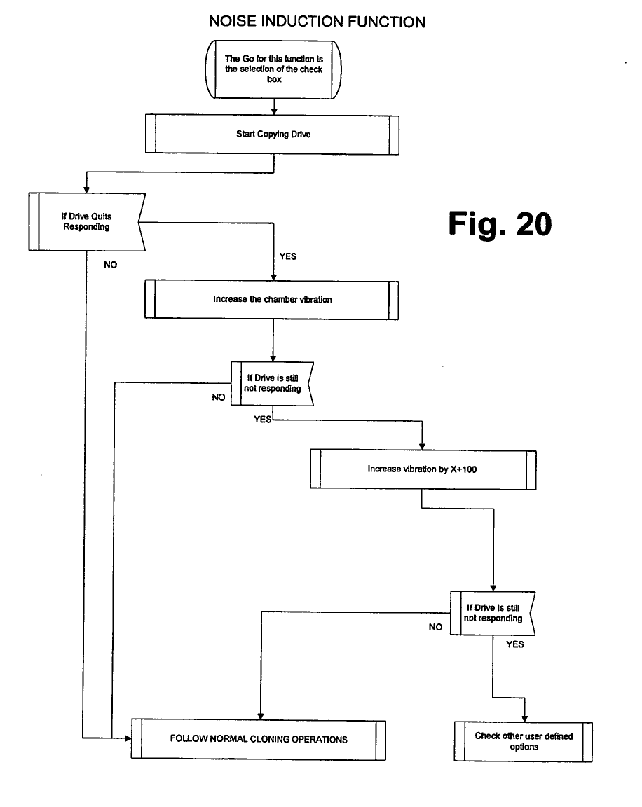

Yet another operation that can be implemented during the function of the steps of the chosen direction set 24 if the hard drive 104 quits responding is the fluctuate vibration and noise option 58. Referring to FIG. 20, the fluctuate vibration and noise option 58 is triggered by the go function of the selection of the option 58, but is implemented after the fluctuate power option 60 and the fluctuate temperature options 56 are unsuccessful, if either were selected. If during data retrieval using one of the direction sets 24, the hard drive 104 quits responding and the fluctuate power option 60 and the fluctuate temperature option 56, if selected, are unsuccessful, the vibration of the chamber 106 is increased to a level of 5 by the software causing the computer 100 to signal the relay 110 to initiate the vibrator 120. If the hard drive 104 still fails to respond, , the vibration of the chamber 106 is increased yet again to 10. If the option 54 was not selected or it was unsuccessful, data retrieval is discontinued. If at any time the drive begins responding with the increase in vibration or after the sleep mode, the steps of FIG. 20 are exited and data retrieval is continued.

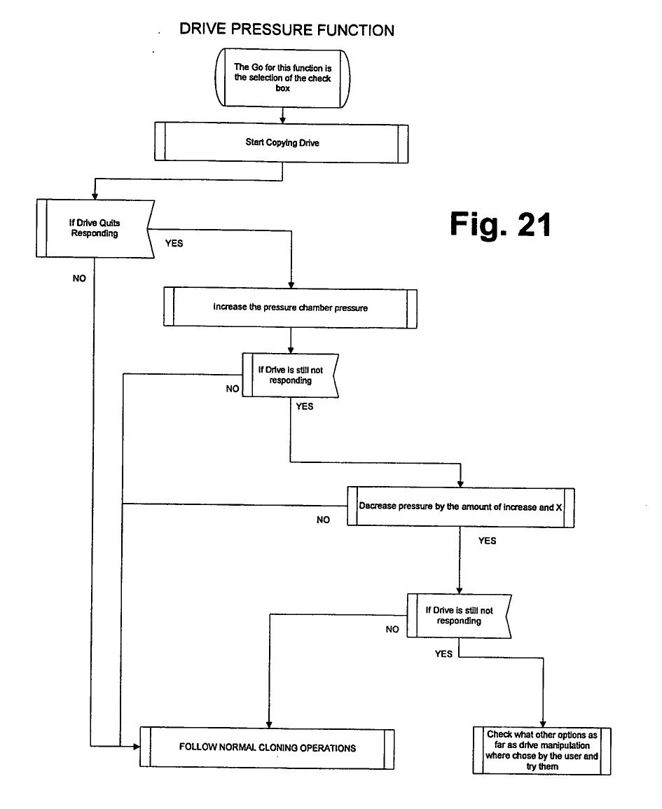

Another operation that can be implemented during the function of the steps of the chosen direction set 24 if the hard drive 104 quits responding is the fluctuate pressure option 54. Referring to FIG. 21, the fluctuate pressure option 54 is triggered by the go function of the selection of the option 54, but is implemented after the fluctuate power option 60, the fluctuate temperature option 56 and the fluctuate vibration option 58 are unsuccessful, if selected. If during data retrieval using one of the direction sets 24, the hard drive 104 quits responding and the fluctuate power option 60, the fluctuate temperature option 56 and the fluctuate vibration option 58, if selected, are unsuccessful, the software causes the computer 100 to signal the relay 110 start the air compressor 112 to increase the pressure within the chamber 106 to 10 psi. If the hard drive 104 does not respond,, the computer 100 signals the relay 110 start the vacuum pump 114 to decrease the pressure within the chamber 106 to −10 psi. If the drive still does not, the data retrieval from the hard drive 104 is aborted.

If the Ignore first X sectors option 66 is checked, the direction sets 24 will ignore and skip the first sectors so specified.

While the specific embodiments have been illustrated and described, numerous modifications come to mind without significantly departing from the spirit of the invention, and the scope of protection is only limited by the scope of the accompanying claims.

We claim:

1. A system for the recovery of data from a failing or failed hard drive comprising:
a computer having a first hard drive and a second hard drive attached thereto, the first hard being the failed or failing hard drive and the second hard drive being a hard drive to which data may be copied from the first hard drive;
computer software executed by the computer for copying data contained on the first hard drive to the second hard drive;
a chamber enclosing at least the first hard drive, the chamber being in communication with the computer, the chamber capable of altering at least one property of environment within the chamber programmatically at direction of the computer software in order to recover data from the first hard drive that was not readable by the computer before the property of environment was altered.

2. The system of claim 1 wherein the property of environment is selected from the group consisting of one or more of pressure, temperature, and vibration.

3. The system of claim 2 wherein the property of temperature is altered with a thermoelectric cooler.

4. The system of claim 2 wherein the property of temperature is altered with a heater.

5. The system of claim 2 wherein the property of pressure is altered with an air compressor.

6. The system of claim 2 wherein the property of pressure is altered with a vacuum pump.

7. The system of claim 1 wherein the computer is in electronic communication with a relay, the relay being responsive to the computer to control at least one of a vacuum pump, an air compressor a heater, a thermoelectric cooler, and a vibration pad.

8. The system of claim 1 wherein the first hard drive is in electronic communication with the computer through the relay.

9. A system for the recovery of data from a failing or failed hard drive comprising:
a computer having a first hard drive and a second hard drive attached thereto, the first hard being the failed or failing hard drive and the second hard drive being a hard drive to which data may be copied from the first hard drive;
computer software executed by the computer for copying data contained on the first hard drive to the second hard drive;
a chamber enclosing at least the first hard drive, the chamber being in communication with the computer, the chamber capable of altering at least one property of environment within the chamber programmatically at direction of the computer software in order to recover data from the first hard drive that was not readable by the computer before the property of environment was altered; and
a relay for receiving a signal from the computer to alter the at least one property of environment.

10. The system of claim 9 wherein the property of environment is selected from the group consisting of one or more of pressure, temperature, and vibration.

11. The system of claim 10 wherein the property of temperature is altered with a thermoelectric cooler.

12. The system of claim 10 wherein the property of temperature is altered with a heater.

13. The system of claim 10 wherein the property of pressure is altered with an air compressor.

14. The system of claim 10 wherein the property of pressure is altered with a vacuum pump.

15. The system of claim 9 wherein the relay is responsive to the computer to control at least one of a vacuum pump, an air compressor a heater, a thermoelectric cooler, and a vibration pad.

16. The system of claim 9 wherein the first hard drive is in electronic communication with the computer through the relay.

17. A method of recovering of data from a failing or failed hard drive comprising the steps of:
operating the failed or failing hard drive to recover the data therefrom;
when an unreadable sector of data on the hard drive is discovered, performing a step selected from the group of:
a. modifying a property of temperature of the hard drive to attempt to read the unreadable sector;
b. modifying a property of pressure of the hard drive to attempt to read the unreadable sector; and
c. modifying a property of vibration of the hard drive to attempt to read the unreadable sector; and
copying the recovered data to a second hard drive.
